(19) United States
(12) Patent Application Publication
(10) Pub. No.: US 2008/0024577 A1
(43) Pub. Date: Jan. 31, 2008

(54) Photo-curing ink composition, ink jet recording method, and ink jet recording apparatus

(75) Inventors: Keitaro Nakano, Matsumoto-shi (JP); Takashi Oyanagi, Shiojiri-shi (JP); Kiyohiko Takemoto, Matsumoto-shi (JP); Chiyoshige Nakazawa, Suwa-shi (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/712,207

(22) Filed: Feb. 28, 2007

(30) Foreign Application Priority Data
Feb. 28, 2006 (JP) 2006-053361
Mar. 8, 2006 (JP) 2006-062783

(51) Int. Cl. B41J 2/01; C09D 11/00; D06P 5/02

(52) U.S. Cl. 347/102; 106/31.13

(57) ABSTRACT

It is an object of the present invention to provide a photo-curing ink composition having excellent curing properties while maintaining low viscosity and good preservation stability and to provide an ink jet recording method and an ink jet recording apparatus which can provide an image with high quality by using the ink composition. The photo-curing ink composition according to the present invention contains at least one of a compound having an allyl group and an N-vinyl compound as a polymerizable compound and contains at least one of thioxanthone and an amine as a polymerization accelerator. In the ink jet recording method and the ink jet recording apparatus according to the present invention, the photo-curing ink composition is used and the light irradiation starts 0.1 to 20 seconds after the discharge of the ink composition from a head to a recording medium.

### TECHNICAL FIELD

The present invention relates to a photo-curing ink composition, an ink jet recording method, and an ink jet recording apparatus. Specifically, the present invention relates to a photo-curing ink composition which provides excellent curing properties while maintaining low viscosity and good preservation stability, an ink jet recording method which produces a very fine image using the ink composition, and an ink jet recording apparatus which likewise produces a very fine image by using the photo-curing ink composition.

### BACKGROUND ART

An ink jet recording method is a printing technology for printing by jetting droplets of ink and attaching them to a recoding medium such as paper. This ink jet recording method has characteristics that an image with high resolution and high quality can be printed at a high speed. The ink used in the ink jet recording method generally contains an aqueous solvent as a main component, a coloring component, and a wetting agent, such as glycerin, for preventing clogging.

When a recording medium is paper, cloth, or the like in which an aqueous ink scarcely penetrates or a recording medium is made of a material such as a metal or a plastic in which an aqueous ink does not penetrate, for example, a plate or a film made of a phenol, melamine, vinyl chloride, acryl, or polycarbonate resin, the ink is required to contain a component for enhancing stable fixation of a color material to the recording material. To such a requirement, for example, Patent Document 1 discloses a photo-curing ink jet ink containing a color material, a photo-curing agent (radical-polymerizable compound), and a (photo-radical) polymerization initiator. It is reported that blurring of ink to a recording medium can be prevented by using this ink and the image quality is improved.

Further, in Patent Document 2, a method for printing with high quality is developed in which the average thickness of an ink dot coating is controlled by controlling the time period from the deposition of ink onto a recording medium till the light irradiation. In addition, Patent Document 3 discloses a method for printing by using an ink jet printer having a characteristic structure for producing an image with high quality on a recording medium and controlling the time period from the deposition of ink onto a recording medium till the light irradiation. Furthermore, Patent Document 4 discloses an ink jet recording method in which an ink jet printer which can control illumination intensity is used for preventing shrinkage or deformation of a recording medium due to being irradiated with ultraviolet light having high illumination intensity for enhancing the photo-curing of ink and simultaneously the time period from the deposition of ink onto a recording medium till the light irradiation is controlled.

Photo-curing ink jet ink used in an ink jet recording method has been recognized that higher polymerizability is preferable for improving the curing property of the ink. Therefore, a method using a polyfunctional compound as the polymerizable compound, a thioxanthone compound as the photo-polymerization initiator, and, according to need, an amine or aminobenzoate compound as the photo-polymerization initiation aid has been developed (Patent Document 5). However, the viscosity of the ink disclosed in Patent Document 5 is high, and therefore treatment such as heating is necessary to use the ink as ink jet ink.

[Patent Document 1] U.S. Pat. No. 5,623,001

[Patent Document 2] JP-T-2003-145914

[Patent Document 3] JP-A-2004-001437

[Patent Document 4] JP-A-2004-106543

[Patent Document 5] JP-T-2000-504778

An object of the present invention to solve the above-mentioned problems in ink disclosed in Patent Document 5 and to provide a photo-curing ink composition which has excellent curing properties while maintaining low viscosity of the ink and has excellent preservation stability.

In addition, in an ink jet recording method using a photo-curing ink, the ink cannot readily spread on a recording medium and an image with lines on it is produced when the curing of the ink is too fast. On the other hand, when the curing of ink is too slow, the ink cannot readily cure because of a change in the ink composition due to oxygen inhibition, or degradation in the image quality is caused by variation in the dot shape. However, in Patent Documents 2 to 5, there is no description of producing an image with high quality by controlling the time period from the deposition of ink till the start of light irradiation on the grounds of the aforementioned matters.

An object of the present invention is to provide an ink jet recording method using the above-mentioned photo-curing ink composition which produces an image with high quality by controlling the time period from the deposition of ink onto a recording medium till the start of light irradiation. Another object of the present invention is to provide an ink jet recording apparatus which likewise produces an image with high quality by using the above-mentioned photo-curing ink composition.

### DISCLOSURE OF THE INVENTION

The present inventors has conducted intensive studies and, as a result, has arrived at the present invention in which the aforementioned object is achieved by employing a structure described below.

That is, the present invention is as follows:

(1) a photo-curing ink composition, the ink composition containing at least one of a compound having an allyl group and an N-vinyl compound as a polymerizable compound and at least one of thioxanthone and an amine as a polymerization accelerator;

(2) the photo-curing ink composition according to the above (1), wherein the compound having an allyl group is allyl glycol;

(3) the photo-curing ink composition according to the above (1), wherein the N-vinyl compound is N-vinyl formamide;

(4) the photo-curing ink composition according to any one of the above (1) to (3), wherein the amine is aminobenzoate;

(5) the photo-curing ink composition according to any one of the above (1) to (4), wherein the ink composition contains 20 to 80 percents by weight of at least one of the compound having an allyl group and the N-vinyl compound;

(6) the photo-curing ink composition according to any one of the above (1) to (5), wherein the ink composition further contains a polymerization initiator and a color material;

(7) an ink jet recording method using a photo-curing ink composition according to any one on the above (1) to (6), wherein light irradiation starts 0.1 to 20 seconds after the discharge of the photo-curing ink composition from a head to a recording medium;

(8) the ink jet recording method according to the above (7), wherein the photo-curing ink composition is a two-liquid type ink composition;

(9) the ink jet recording method according to the above (8), wherein the two liquids of the ink composition are mixed before the discharge from a head;

(10) the ink jet recording method according to the above (8), wherein the two liquids of the ink composition are mixed on a recording medium;

(11) the ink jet recording method according to any one of the above (7) to (10), wherein the light curing of the photo-curing ink composition is ultraviolet light-curing;

(12) the ink jet recording method according to the above

(11), wherein the light source for light irradiation is a light-emitting diode or a laser diode; and

(13) an ink jet recording apparatus using a photo-curing ink composition according to any one on the above (1) to (6), the apparatus having a mechanism for starting light irradiation 0.1 to 20 seconds after the discharge of the photo-curing ink composition from a head to a recording medium.

The photo-curing ink composition according to the present invention contains at least one of a compound having an allyl group and an N-vinyl compound as a polymerizable compound and at least one of thioxanthone and an amine as a polymerization accelerator, and thereby the curing properties can be improved while maintaining low viscosity and good preservation stability.

In addition, in the ink jet recording method and the ink jet recording apparatus according to the present invention, an image with high quality can be produced by starting the light irradiation 0.1 to 20 seconds after the discharge of the photo-curing ink composition from a head to a recording medium. Further, an excellent image can be produced by controlling the time period from the deposition of ink onto a recording medium till the start of light irradiation and designing the composition of ink and a light source for light irradiation.

### BRIEF DESCRIPTION OF THE DRAWINGS

FIG. 1 is a schematic perspective diagram showing a main structure of an ink jet printer on which a light-irradiating device of an ink jet recording apparatus according to an embodiment of the present invention is mounted.

FIG. 2 is an enlarged perspective view of the light-irradiating device shown in FIG. 1.

FIG. 3 is a block diagram showing an electrical structure of the ink jet printer shown in FIG. 1.

FIG. 4 is an explanatory diagram of an exposure area when a plurality of light-emitting elements forming elliptical light images is arrayed in such a manner that the elliptical light images of each element are successively produced along the minor axis direction.

FIG. 5 is a diagram showing another example of the elliptical light images c in a successive state.

In addition, each reference numeral in the figures denotes the followings:

20: ink jet printer, 30: paper-transporting motor, 32: rotary encoder, 34: paper-transporting roller, 40: platen, 50: carriage, 52: printing head (recording head), 54: black cartridge, 56: color ink cartridge, 60: carriage motor, 62: tow belt, 64: guide rail, 70: linear encoder, 72: code plate, 74: photosensor, 80: capping device, 90: light-irradiating device, 91: element holder, 91a: mounting face, 92: bracket, 93: bracket, 95: light-emitting element, 102: main control circuit, 104: CPU, 110: ROM, 112: RAM, 114: EEPROM, 120: interface circuit, 130: paper-transporting motor-driving circuit, 140: head-driving circuit, 150: CR motor-driving circuit, 160: light-irradiating device-driving circuit, P: printing paper (recording medium)

### BEST MODE FOR CARRYING OUT THE INVENTION

The present invention will now be described in detail.

The photo-curing ink composition according to the present invention characteristically contains at least one of a compound having an allyl group and an N-vinyl compound as a polymerizable compound.

Thus, an operational advantage of allowing reducing the viscosity is achieved by containing at least one of a compound having an allyl group and an N-vinyl compound as a polymerizable compound.

In the present invention, the compound having an allyl group used as a polymerizable compound is a collective designation for compounds having a 2-propenyl structure (—CH₂CH═CH₂). The 2-propenyl group is also called an allyl group and is a trivial name according to the IUPAC nomenclature system.

Examples of the compound having an allyl group include allyl glycol (manufactured by Nippon Nyukazai Co., Ltd.), and trimethylolpropane diallyl ether, pentaerythritol triallyl ether, and glycerin monoallyl ether (manufacture by Daiso Co., Ltd.), and polyoxyalkylene compounds having an allyl group which are marketed under product names UNIOX, UNILUB, POLYCERIN, and UNISAFE (manufactured by NOF Corp.). Among them, allyl glycol is particularly preferable as the compound having an allyl group.

Examples of the above-mentioned N-vinyl compound include N-vinylformamide, N-vinylcarbazol, N-vinylacetamide, N-vinylpyrrolidone, N-vinylcaprolactam, and derivatives thereof. In particular, N-vinylformamide is preferable.

In the photo-curing ink composition according to the present invention, the ink composition preferably contains 20 to 80 percents by weight of at least one of the compound having an allyl group and the N-vinyl compound. An operational advantage of “allowing reducing the viscosity” can be suitably achieved by adjusting the content within this range, compared to the case outside the range.

In addition, the photo-curing ink composition according to the present invention characteristically contains at least one of thioxanthone and an amine as a polymerization accelerator.

Thus, an operational advantage of improving the curing properties while maintaining good preservation stability is achieved by containing at least one of thioxanthone and an amine as a polymerization accelerator.

Examples of concrete product name of the thioxanthone used in the present invention include DarcurITX, QuantacureCTX, and KayacureDETX-S.

In addition, examples of the amine include tetramethylethylene diamine (TEMD), and preferable example is aminobenzoate.

Examples of concrete product name of the amine or aminobenzoate include DarcurEHA and DarcurEDB (manufactured by Ciba Specialty Chemicals Inc.).

In the photo-curing ink composition according to the present invention, the ink composition preferably contains 0.1 to 10 percents by weight of at least one of the thioxanthone and the amine. An operational advantage of “improving the curing properties while maintaining good preservation stability” can be suitably achieved by adjusting the content within this range, compared to the case outside the range.

The photo-curing ink composition according to the present invention may contain a photo-radical polymerization initiator.

Examples of the photo-radical polymerization initiator include benzyldimethyl ketal, α-hydroxyalkylphenone, α-aminoalkylphenone, acylphosphine oxide, oxime ester, thioxanthone, α-dicarbonyl, and anthraquinone. In addition, photo-polymerization initiators available under product names of Vicure 10 and 30 (manufactured by Stauffer Chemical Company), Irgacure 127, 184, 500, 651, 2959, 907, 369, 379, 754, 1700, 1800, 1850, and 819, OXE01, Darocur 1173, TPO, and ITX (manufactured by Ciba Specialty Chemicals Inc.), Quantacure CTX (manufactured by AcetoChemical Corp.), Kayacure DETX-S (manufactured by Nippon Kayaku Co., Ltd.), and ESACURE KIP150 (manufactured by Lamberti Co.) can be also used.

In addition, the photo-curing ink composition according to the present invention may contain a surfactant. Examples of concrete surfactant product name include BYK-UV3570 and BYK-UV3500.

Further, the photo-curing ink composition according to the present invention may contain a color material. Though the color material used in this case may be either a dye or a pigment, a pigment is useful from the viewpoint of durability of the printed matter.

As the dye which can be used in the present invention, various dyes generally used in ink jet recording can be used. Examples of the dye include direct dyes, acid dyes, food dyes, basic dyes, reactive dyes, disperse dyes, vat dyes, soluble vat dyes, and reactive disperse dyes.

As the pigment which can be used in the present invention, inorganic pigments and organic pigments can be used without specific limitation.

As the inorganic pigment, titanium oxide and iron oxide can be used. In addition, carbon black manufactured by a known method such as the contact method, furnace method, or thermal method can be used. As the organic pigment, for example, azo pigments (including azolake, insoluble azo pigments, condensed azo pigments, and chelate azo pigments), polycyclic pigments (for example, phthalocyanine pigments, perylene pigments, perinone pigments, anthraquinone pigments, quinacridone pigments, dioxazine pigments, thioindigo pigments, isoindolinone pigments, and quinophthalone pigments), dye chelates (for example, basic dye chelates and acid dye chelates), nitro pigments, nitroso pigments, and aniline black can be used.

Examples of the pigment used as carbon black include Nos. 2300 and 900, MCF88, Nos. 33, 40, 45, and 52, MA7, MA8, MA100, and No. 2200B manufactured by Mitsubishi Chemical Corp., Raven 5750, 5250, 5000, 3500, 1255, and 700 manufactured by Colombia Carbon Co., Regal 400R, 330R, and 660R, Mogul L and 700, Monarch 800, 880, 900, 1000, 1100, 1300, and 1400 manufactured by Cabot Co., Color Black FW1, FW2, FW2V, FW18, and FW200, ColorBlack S150, S160, and S170, Printex 35, U, V, and 140U, Special Black 6, 5, 4A, and 4 manufactured by Degussa Company.

Examples of the pigment used as yellow ink include C.I. pigment yellow 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213.

Examples of the pigment used as magenta ink include C.I. pigment red 5, 7, 12, 48 (Ca), 48 (Mn), 57 (Ca), 57:1, 112, 122, 123, 168, 184, 202, and 209, and C.I. pigment violet 19.

In addition, examples of the pigment used as cyan ink include C.I. pigment blue 1, 2, 3, 15:4, 60, 16, and 22.

In a preferable embodiment in which a pigment is contained in a photo-curing ink composition according to the present invention, the average particle size of the pigment is preferably in the range of 10 to 200 nm, more preferably about 50 to 150 nm. Further, the addition amount of a color material to a photo-curing ink composition is preferably in the range of about 0.1 to 25 percents by weight, more preferably in the range of about 0.5 to 15 percents by weight.

The pigment is dispersed in an aqueous medium with a dispersing agent or a surfactant, and the resulting pigment dispersion liquid can be used as a photo-curing ink composition. A dispersing agent that is usually used for preparing pigment dispersion liquid, for example, a high-molecular dispersing agent, can be used as a preferable dispersing agent.

In addition, when the photo-curing ink composition contains a color material, a plurality of photo-curing ink compositions may be prepared for each color. For example, when deep and light similar colors for each of four fundamental colors, i.e., yellow, magenta, cyan, and black, are prepared, ink compositions of light magenta as a light color and red as a deep color as well as magenta, light cyan as a light color and blue as a deep color as well as cyan, and gray and light black as light colors and mat black as a deep color as well as black may be prepared.

The photo-curing ink composition according to the present invention may contain a wetting agent, a permeation solvent, a pH-adjusting agent, an antiseptic agent, and a fungicide, which can be used in an ultraviolet light-curing ink composition as other known and publicly used components.

In addition, according to need, a leveling additive agent, a mat agent, and a polyester resin, polyurethane resin, vinyl resin, acrylic resin, rubber resin, or wax for adjusting film properties can be added.

Further, the photo-curing ink composition according to the present invention may be a one-liquid type or a two-liquid type.

When the ink composition is a two-liquid type, the two liquids can be mixed before the discharge from a printer head or mixed on a recording medium after the discharge.

The mixing of the liquids after the discharge can be performed by discharging the two types of ink to the same position on a recording medium.

The curing reaction of the photo-curing ink composition according to the present invention is performed by light irradiation.

The light irradiation source is not specifically limited, but preferably irradiates light containing a wavelength of 350 nm or more but not exceeding 450 nm.

When ultraviolet light is used, the exposure dose of the ultraviolet light is 10 mJ/cm² or more but not exceeding 10000 mJ/cm², preferably 50 mJ/cm² or more but not exceeding 6000 mJ/cm². The curing reaction can be sufficiently performed by ultraviolet light exposure in such a dose range.

In addition, ultraviolet light having a long wavelength range of 350 nm or more does not generate ozone and is preferably used for irradiation from the standpoint of safety and environment. Further, ultraviolet light not having a continuous spectrum but having a narrow light-emission peak width is preferably used for irradiation. The light-emission peak wavelength is preferably in the range of 350 to 420 nm.

The light source for light irradiation may be a light-emitting diode or a laser diode.

When ultraviolet light is irradiated, an ultraviolet-emitting semiconductor element such as an ultraviolet LED or an ultraviolet light-emitting semiconductor laser is preferable in view of energy consumption, miniaturization, and lamp service life. When the ultraviolet LED is used, it is preferred to combine an LED having a light-emission peak wavelength of 365 nm, an LED having a light-emission peak wavelength of 380 nm, and an LED having a light-emission peak wavelength of 395 nm, for example.

In a case of ultraviolet light, the exposure dose range of the ultraviolet light is 10 mJ/cm² or more but not exceeding 10000 mJ/cm², preferably 50 mJ/cm² or more but not exceeding 6000 mJ/cm². The curing reaction can be sufficiently performed in such a dose range of the ultraviolet light exposure.

Examples of other ultraviolet-irradiating means include lamps such as a metal halide lamp, a xenon lamp, a carbon arc lamp, a chemical lamp, a low-pressure mercury lamp, and a high-pressure mercury lamp. For example, commercially available lamps such as H Lamp, D Lamp, and V Lamp manufactured by Fusion System can be used.

An ink jet recording method according to the present invention uses the above-described photo-curing ink composition, and when recording on a recording medium using this photo-curing ink composition is conducted, light irradiation starts 0.1 to 20 seconds after the discharge of the photo-curing ink composition from an ink jet printer head to the recording medium.

When a light source is mounted on a carriage, the time period from the discharge till the light irradiation can be adjusted by changing the distance between a nozzle for discharging the ink and the light source or by changing the scanning speed of the carriage. On the other hand, when a light source is mounted on a printer main unit, the time period from the discharge till the light irradiation can be adjusted by changing the recording medium-transporting speed or by changing the timing of lighting the light source. When the curing is slow, the ink does not readily cure because of oxygen inhibition, or variation in the dot shape is caused by a change in the recording medium. Contrarily, when the curing is fast, the ink does not readily spread on a recording medium, and an image with lines on it is produced. These problems can be solved by adjusting the time period till the start of light irradiation to 0.1 to 20 seconds. As a result, an image with high quality can be produced.

When the photo-curing ink composition is a two-liquid type ink composition, the two liquids of the ink composition are mixed before the discharge from a head or are mixed on a recording medium. Further, when the photo-curing of the photo-curing ink composition is ultraviolet light-curing, the light source for the light irradiation is a light-emitting diode or a laser diode.

In an ink jet recording apparatus according to the present invention, the above-described photo-curing ink composition is used as in the ink jet recording method according to the present invention. The ink jet recording apparatus has a mechanism for starting light irradiation 0.1 to 20 seconds after the discharge of the photo-curing ink composition from a head to a recording medium.

The ink jet printer (ink jet recording apparatus) using the photo-curing ink composition is not specifically limited as long as the light irradiation is not prevented. An example of such an ink jet recording apparatus will now be described with reference to drawings.

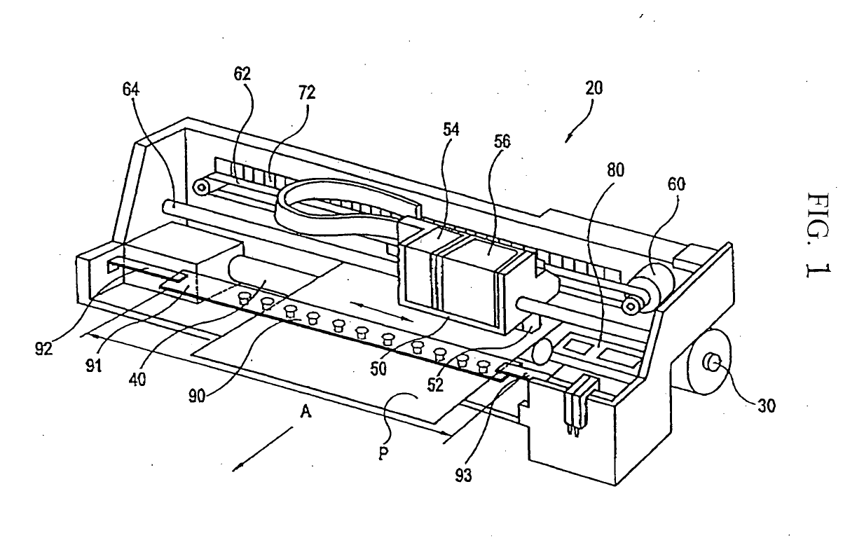

FIG. 1 is a schematic perspective diagram showing a main structure of an ink jet printer 20 according to an embodiment of the present invention.

The printer 20 is provided with a paper-transporting motor 30 for transporting printing paper P as a recording medium, a platen 40, a printing head 52 as a recording head for ejecting photo-curing ink as microparticles to printing paper P for adhesion, a carriage 50 loaded with this printing head 52, a carriage motor 60 for moving the carriage 50 in the main scanning direction, and a light-irradiating device 90 for irradiating light of a specific wavelength range to the ink-adhered face of the printing paper P on which a photo-curing ink is adhered by the printing head 52.

The carriage 50 is towed by a tow belt 62 which is driven by the carriage motor 60 and moves along a guide rail 64. The carriage 50 is loaded with, in addition to the printing head 52, a black cartridge 54 as a black ink container for storing black ink to be supplied to the printing head 52 and a color ink cartridge 56 as a color ink container for storing color ink to be supplied to the printing head 52.

The ink stored in the cartridges 54 and 56 is photo-curing ink which is cured by exposure to ultraviolet light or visible light near the ultraviolet range.

At the home position (the position at the right in FIG. 1) of the carriage 50, a capping device 80 for sealing the nozzle face of the printing head 52 in the stopped state is disposed. When a printing job is finished and the carriage 50 reaches above the capping device 80, the capping device 80 automatically raises by a mechanism not shown in the figure to seal the nozzle face of the printing head 52. The capping prevents the ink in the nozzle from drying. The positioning of the carriage 50 is controlled, for example, so that the carriage 50 is precisely placed at the position of the capping device 80.

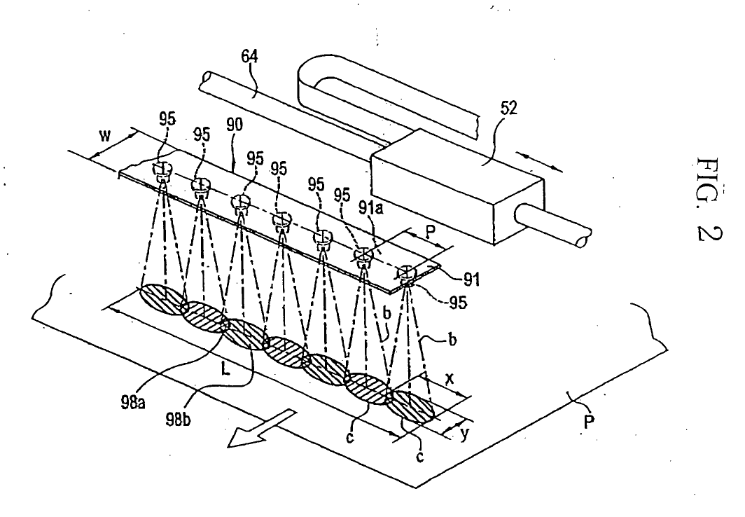

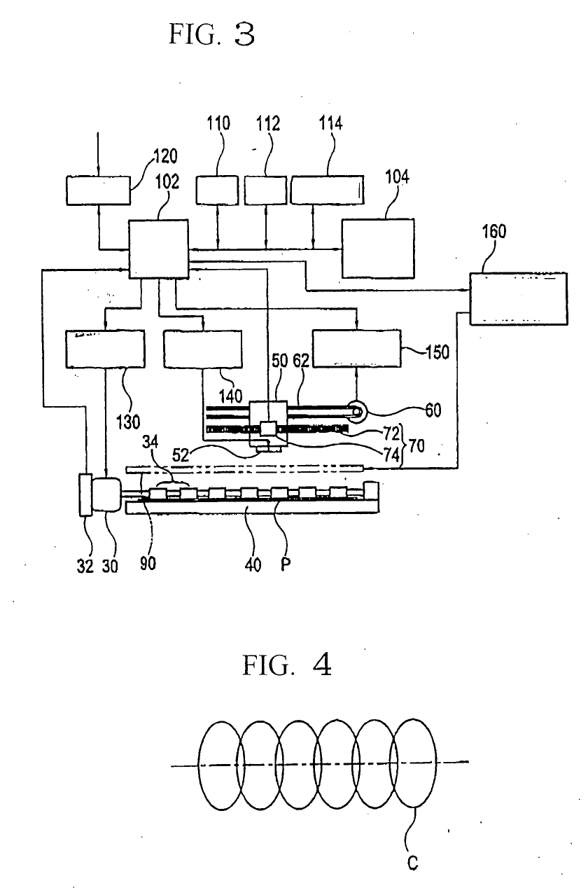

The light-irradiating device 90 is, as shown in FIGS. 1 and 2, provided with a plurality of light-emitting elements 95 for emitting light of a specific wavelength range, an element holder 91 for holding these light-emitting elements 95 aligned along the width direction of printing paper P, brackets 92 and 93 for fixing the element holder 91 to a housing of a printer 20, and a light-irradiating device-driving circuit 160 (see FIG. 3) for controlling the light emission and extinguish of the light-emitting elements 95.

The element holder 91 is a plate-like structure having a predetermined width W (see FIG. 2) along the transporting direction of printing paper P in the printer 20 and a predetermined length A (see FIG. 1) along the width direction of the printing paper P. The length A is set to be larger than the width of paper which is the largest among paper used in the printer 20.

The element holder 91 is disposed so as to be parallel to a surface of printing paper P which is irradiated with light and is fixed to the housing of the printer 20 with the brackets 92 and 93.

The face of the element holder 91 which opposes a surface of printing paper P is the mounting face 91a for mounting the light-emitting elements 95.

The element holder 91 is disposed at a position remote from the printing head 52 by a predetermined distance toward the downstream side of the transporting direction of printing paper P.

The brackets 92 and 93 fix the ends of the element holder 91 to the housing of the printer 20 by screwing or fitting.

In this embodiment, every light-emitting element 95 emits light b of a specific wavelength range effective for curing the photo-curing ink which is ejected by the printing head 52 and applied to printing paper P and produces an elliptical light image c on the surface of the printing paper P which is irradiated with light.

The elliptical light image c shows an irradiated area of the printing paper P with the light emitted from each of the light-emitting elements 95. The light images c are the same sized ellipses each having the same a major axis x and a minor axis y.

In this specification, the ratio x/y of the major axis x to the minor axis y is defined as the aspect ratio of an ellipse, like the aspect ratio of a rectangle. Here, each light-emitting element 95 produces an elliptical light image c having an aspect ratio of 2.0 or more.

In addition, as shown in FIG. 2, the light-emitting elements 95 are aligned on the mounting face 91a of the element holder 91 in a line along the width direction of printing paper P.

The total number of the light-emitting elements 95 provided to the mounting face 91a in a line is n. These n light-emitting elements 95 are attached to the mounting face 91a with predetermined intervals p therebetween so that the light images c produced successively along the major axis direction overlap each other at their ends in the major axis direction.

As a result, an approximately strip-shaped irradiation area 98 in which the light images c are aligned one after the other along the width direction of printing paper P is formed.

The irradiation area 98 has a structure in which irradiation areas 98a and irradiation areas 98b are alternately aligned. The irradiation areas 98a are formed by the ends of overlapped adjacent light images c and have high exposure intensity, and the irradiation areas 98b have the fundamental exposure intensity at the light image c.

When the total number of the used light-emitting elements 95 is n, this irradiation area 98 has an approximately strip-like shape with a size L (L≈np) in the width direction of printing paper P and a size y in the transporting direction of the printing paper P.

In addition, in this embodiment, semiconductor laser elements are employed as the light-emitting elements 95. Further, the light-emitting elements are preferably selected so that the peak wavelength of the light of a specific wavelength range output by the semiconductor laser elements is not the same as the absorption wavelength of the light-absorbing material in the photo-curing ink.

For example, as a light-emitting element emitting ultraviolet light with a wavelength shorter than 400 nm, semiconductor laser diode series, model number NDHU110APAE2 (oscillation wavelength: 370 to 380 nm) manufactured by Nichia Corp. can be used.

In addition, as an element emitting visible light with a wavelength of 400 to 450 nm, semiconductor laser diode series, model number NDHV310APC, NDHV220AOAE1 (oscillation wavelength: 400 to 415 nm), or model number NDHB20APAE1 (oscillation wavelength: 435 to 445 nm) manufactured by Nichia Corp. can be used.

Next, an electrical structure of the printer 20 will be described with reference to FIG. 3. FIG. 3 is a block diagram showing an electrical structure of the printer 20.

The printer 20 is provided with a main control circuit 102, a CPU 104, and various memories (ROM 110, RAM 112, EEPROM 114) which are connected to the main control circuit 102 and the CPU 104 via a bus.

The main control circuit 102 is connected to an interface circuit 120 for transmitting and receiving signals to and from an external apparatus such as a personal computer, a paper-transporting motor-driving circuit 130, a head-driving circuit 140, a CR motor-driving circuit 150, and a light-irradiating device-driving circuit 160 for controlling the operation of the light-irradiating device 90.

A paper-transporting motor 30 is driven by the paper-transporting motor-driving circuit 130 to rotate paper-transporting rollers 34 and thereby move printing paper P to the transporting direction. The paper-transporting motor 30 is provided with a rotary encoder 32. The output signal of the rotary encoder 32 is input into the main control circuit 102.

A printing head 52 having a plurality of nozzles (not shown) is disposed on the bottom face of a carriage 50. Each nozzle is driven by the head-driving circuit 140 and discharges ink droplets of photo-curing ink supplied from cartridges 54 and 56 toward a recording medium such as paper, cloth, or film.

A carriage motor 60 is driven by the CR motor-driving circuit 150. This printer 20 is provided with a linear encoder 70 for detecting the carriage 50 for the position and speed along the main scanning direction. This linear encoder 70 is composed of a linear code plate 72 disposed parallel to the main scanning direction and a photosensor 74 provided to the carriage 50. The output signal of the linear encoder 70 is input into the main control circuit 102.

The light-irradiating device-driving circuit 160 controls the light emission and extinguish of each light-emitting element 95 based on the control signal delivered from the main control circuit 102.

Specifically, when the printing starts by the driving of the printing head 52 or when a face of printing paper P adhered with photo-curing ink reaches the irradiation area 98 irradiated with light of a specific wavelength range by the light-irradiating device 90 by the starting of the printing operation, all light-emitting elements 95 mounted on the element holder 91 are turned to a light-emitting state and are kept at the light-emitting state until the face of printing paper P adhered with photo-curing ink passes over the irradiation area 98 irradiated with light of a specific wavelength range by the light-irradiating device 90. That is, each light-emitting element 95 successively. emits light until the face of printing paper P adhered with photo-curing ink passes over the irradiation area 98 irradiated with light of a specific wavelength range by the light-irradiating device 90.

In addition, the main control circuit 102 has a function for providing control signals to the respective four driving circuits 130, 140, 150, and 160 and also has functions for decoding various printing commands which are received by the interface circuit 120, controlling the adjustment of printing data, and performing monitoring of various types of sensors. The CPU 104 also has various functions for assisting the main control circuit 102, such as performing the control of various memories.

In the above-described light-irradiating device 90, the light-emitting elements 95 are aligned with predetermined intervals therebetween in the major axis direction of elliptical light images c formed by the light-emitting elements so that the light images c are produced successively along the major axis direction of the ellipses. Therefore, a light-irradiating method in which an approximately strip-like irradiation area 98 of elliptical light images c aligned successively in the major axis direction is formed on printing paper P at the area to which ink is applied can be performed.

Then, the interval p between the adjacent light-emitting elements can be set larger compared to that in a case that light-irradiation device in which light-emitting elements are aligned so that the elliptical light images c are produced successively along the minor axis direction as shown in FIG. 4. Further, as shown in FIG. 2 as the approximately strip-like irradiation area 98, a larger width L can be irradiated with light of a specific wavelength range by using a smaller number of the light-emitting elements.

Therefore, when light of a specific wavelength range is irradiated to an exposure face over a predetermined width, it is possible to reduce the cost by decreasing the number of the light-emitting elements as light sources.

Further, since the light emitted from each light-emitting element 95 becomes diffusion light, the major axis x and the minor axis y of a light image c are changed in association with a change in the distance between the light-emitting element 95 and the exposure face of printing paper P by adjusting the mounting position of the element holder 91.

In this embodiment, in a case that a semiconductor laser diode model number NDHV310APC (the light diffusion at the FWHM is (θ∥) 8° in the minor axis direction of a light image and (θ⊥) 22° in the major axis direction) manufactured by Nichia Corp. was used as the light-emitting element, the light image c had a major axis x of 24.1 mm, a minor axis y of 9.95 mm, and an aspect ratio of 2.20 when the distance (irradiation distance) between the light-emitting element 95 and the exposure face of printing paper P was 30 mm.

In addition, when the distance (irradiation distance) between the same light-emitting element 95 and the exposure face of printing paper P was 50 mm, the light image c had a major axis x of 39.1 mm, a minor axis y of 15.5 mm, and an aspect ratio of 2.36.

Further, in each irradiation distance, a case of a light-emitting element alignment according to the embodiment shown in FIG. 2 and a case of an element alignment shown in FIG. 4 for comparison were compared for the number of the light-emitting elements which was necessary for forming the irradiation area 98 over the width (210 mm) of A4 size printing paper P.

When the irradiation distance was 30 mm, nine light-emitting elements were necessary in the element alignment according to the embodiment shown in FIG. 2, but twenty-two light-emitting elements were necessary in the element alignment according to the comparison example shown in FIG. 4. Thus, it was confirmed that the number of the elements can be considerably reduced by employing the above-described embodiment.

Further, when the irradiation distance was 50 mm, six light-emitting elements were necessary in the element alignment according to the embodiment shown in FIG. 2, but fourteen light-emitting elements were necessary in the element alignment according to the comparison example shown in FIG. 4. Thus, it was also confirmed in this case that the number of the elements can be considerably reduced by employing the above-described embodiment.

Furthermore, since the distance p between the light-emitting elements 95 serving as light sources can be set larger, the spaces between the light-emitting elements 95 are hardly filled with the heat generated by each light-emitting element 95, and therefore the light-emitting elements 95 themselves can be prevented from being damaged by the heat. Thus, a reduction in the service life of the light sources due to heat damage can be prevented.

Therefore, as shown in the above-described embodiment, when the light-irradiating device 90 is mounted on an ink jet printer 20 at near the printing head 52 thereof and the photo-curing ink adhered by the printing head 52 of the printer 20 on printing paper P as a recording medium is cured by light irradiation, the light-irradiating device 90 itself is prevented from generating heat. Consequently, it is not necessary that the printer 20 is equipped with cooling operation or means such as a cooling fan. Thus, miniaturization of the ink jet printer 20 and cost reduction are also provided.

Photo-curing ink can efficiently progress the curing process by being exposed to ultraviolet light having a specific wavelength. The curing process can be also performed by irradiating visible light near the ultraviolet range, instead of ultraviolet light, though the efficiency of the curing is low compared to that of ultraviolet light irradiation.

In general, an ultraviolet light-emitting element is more expensive than a visible light-emitting element.

Therefore, a light-irradiating device 90 with a proper balance between cost and performance can be provided by preparing for employment of an inexpensive visible light-emitting element by taking the price difference between an ultraviolet light-emitting element and a visible light-emitting element and the required processing speed into account.

In photo-curing ink, a difference in the wavelength range of light absorbed by the ink when it is irradiated with light is caused by a difference in the composition of components such as a color material (pigment, dye, or the like) and others, and thereby a difference in the curing time of ink may occur.

Therefore, as in the above-described embodiment, light irradiation with a broad wavelength range containing a plurality of light-emission peaks is possible by forming an alignment of a plurality of light-emitting elements having different light-emission peak wavelengths. Therefore, even if light having a part of light-emission peak wavelengths is absorbed, the curing efficiency of ink can be stably maintained by the function of the light having other light-emission peak wavelengths. In addition, it is applicable to various types of photo-curing ink which are different in the light-emission peak wavelength of the irradiation light to be absorbed. Consequently, it is possible to expand the versatility of the light-irradiating device 90 by increasing the applicable types of ink.

Further, in the case that the aspect ratio of an elliptical light image c is adjusted to 2.0 or more as in this embodiment, the difference in the intervals between the light-emitting elements when the elliptical light images c are aligned in the major axis direction and aligned in the minor axis direction becomes significantly large compared to the case that light-emitting elements forming elliptical light images are aligned so that the aspect ratio is less than 2.0. Consequently, the reduction in the number of the light-emitting elements 95 serving as light sources and the broadening of the intervals between the light-emitting elements 95 accelerate the diffusion of the heat generated by the light-emitting elements 95. Thus, the effectiveness that the light-emitting elements 95 are prevented from being degraded by heat damage due to the heat filling the spaces between the light-emitting elements 95 becomes clear.

In addition, as in this embodiment, when a semiconductor laser element is used as the light-emitting element 95, the emitted light produces an elliptical light image c due to the structure of the semiconductor laser element itself such as a semiconductor laser diode. Thus, elliptical light images c which are effective for broadening the intervals between the light-emitting elements 95 can be obtained without using a specific optical means.

Further, in the light emission by a semiconductor laser element, the emitted light diffuses more than the light emitted by a solid laser. Therefore, one light-emitting element 95 can irradiate broader area with light beams. Consequently, the semiconductor laser element is effective for reducing the number of light-emitting elements to be used, and simultaneously a scanning mechanism for broadening the area irradiated with light beams is not required to be combinedly used. Thus, the broadened area irradiated with light beams can be achieved inexpensively.

In addition, since a scanning mechanism is not required, a structure in which the light-emitting elements 95 are attached to the movable portion for scanning is not required. Thus, it is possible to design a structure not having a movable portion which tends to cause a breakdown. Consequently, the operation reliability and durability as a light-irradiating device 90 can be improved.

Further, in the above-described embodiment, the light-emitting elements 95 are aligned in one line, but may be aligned in a plurality of lines. By arranging the light-emitting elements in a plurality of parallel lines, the whole irradiation area can be adjusted to an optional size along the transporting direction of printing paper P without any limitation by the major axis x and the minor axis y of the elliptical light image produced by a single light-emitting element. Therefore, the processing speed can be enhanced by increasing the number of the lines of the light-emitting elements to broaden the light irradiation area in the recording medium-transporting direction.

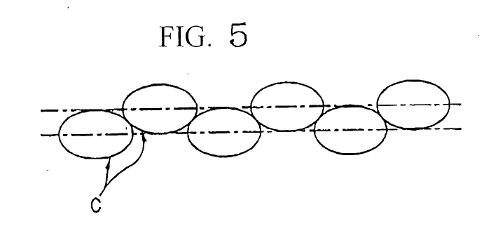

Further, the successive state of the elliptical light images c along the width direction of printing paper P may be designed as shown in FIG. 5.

In addition, the emission wavelength of a semiconductor laser element used as the light-emitting element according to the present invention is desirably determined based on the properties of the photo-curing ink to be processed, and some emission wavelengths other than those shown in the above-described embodiment can be suitably used depending on the properties of the photo-curing ink.

In addition, the light-emitting element which can be used in the present invention is not limited to semiconductor laser elements. Elements other than semiconductor laser elements can be used as long as beams emitted from the elements become diffusion light to produce elliptical light images.

Further, when a line of light-emitting elements is formed by light-emitting elements which emit light of approximately the same wavelength range, the light-emitting elements may have the same light-emission peak wavelength only or may have different light-emission peak wavelengths.

In addition, in the above-described embodiment, the light-emitting elements 95 of the light-irradiating device 90 are set to successively emit light during the printing process, but may be set to perform pulsed emission per a certain time based on the properties of the using photo-curing ink and information of the printing area (such as the amount of the ejected and applied photo-curing ink) for limiting the dose of irradiation light to the minimum.

With this, the light dose irradiated to photo-curing ink is limited to the minimum to achieve a reduction in the power consumption of the light-irradiating device 90, a decrease in the heat generation by the light-emitting elements 95, and an increase in the service life due to the reduction of the service hours of the light-emitting elements 95.

Further, in the above-described embodiment, a serial-type head which ejecting ink while moving the head 52 is used. However, a line-type head which adhering ink to a recording medium by linearly ejecting ink in the width direction of printing paper without moving the head may be used.

### EXAMPLES

The present invention will now be further specifically described with reference to Examples and Comparative Examples, but the present invention is not limited to them.

### Examples 1 to 8, Comparative Examples 1 to 8

Ink compositions shown in Tables 1 to 4 were prepared. Proportions of each component of the ink compositions are expressed by parts by weight. In ink compositions of Examples 1 to 8 shown in Tables 1 to 4, “allyl glycol” was used as the compound having an allyl group (polymerizable compound), “N-vinyl formamide” was used as the N-vinyl compound (polymerizable compound), “Darocur ITX” was used as the thioxanthone (polymerization accelerator), and “Darcur EHA” was used as the amine (polymerization accelerator). In addition, Comparative Examples 1, 3, 5, and 7 were ink compositions not containing amines, and Comparative Examples 2, 4, 6, and 8 were ink compositions not containing the compounds having an allyl group and N-vinyl compounds.

[Table 1]

TABLE 1
Black

| | Exam- | Example 2 | | Comparative | Comparative |
|---|---|---|---|---|---|
| | ple 1 | A | B | Example 1 | Example 2 |
| Allyl glycol | 31.2 | 25 | 41 | 33.2 | |
| N-vinyl formamide | 25 | | 21.2 | 25 | |
| Tripropylene | 25 | 67.9 | | 25 | 55 |
| glycol | | | | | |
| diacrylate | | | | | |
| Trimethylolpropane | 8 | | 33 | 8 | 34.2 |
| triacrylate | | | | | |
| EO adduct | | | | | |
| Irgacure 1800 | 5 | 5 | | 5 | 5 |
| Darocur EHA | 1 | 1 | 1 | | 1 |
| Darocur ITX | 1 | 1 | | | 1 |
| BYK-UV 3570 | 0.1 | 0.1 | 0.1 | 0.1 | 0.1 |
| Pigment black-7 | 3 | | 3 | 3 | 3 |
| Dispersing agent | 0.7 | | 0.7 | 0.7 | 0.7 |
| (polyoxyalkylene | | | | | |
| polyalkylene | | | | | |
| polyamine) | | | | | |

[Table 2]

TABLE 2
Cyan

| | Exam- | Example 4 | | Comparative | Comparative |
|---|---|---|---|---|---|
| | ple 3 | A | B | Example 3 | Example 4 |
| Allyl glycol | 31.2 | | 41 | 33.2 | |
| N-vinyl formamide | 25 | 25 | 21.2 | 25 | |
| Tripropylene | 25 | 67.9 | | 25 | 55 |
| glycol | | | | | |
| diacrylate | | | | | |
| Trimethylolpropane | 8 | | 33 | 8 | 34.2 |
| triacrylate | | | | | |
| EO adduct | | | | | |
| Irgacure 1800 | 5 | 5 | | 5 | 5 |
| Darocur EHA | 1 | 1 | 1 | | 1 |
| Darocur ITX | 1 | 1 | | | 1 |
| BYK-UV 3570 | 0.1 | 0.1 | 0.1 | 0.1 | 0.1 |
| Pigment blue-15:3 | 3 | | 3 | 3 | 3 |
| Dispersing agent | 0.7 | | 0.7 | 0.7 | 0.7 |
| (polyoxyalkylene | | | | | |
| polyalkylene | | | | | |
| polyamine) | | | | | |

[Table 3]

TABLE 3
Magenta

| | Exam- | Example 6 | | Comparative | Comparative |
|---|---|---|---|---|---|
| | ple 5 | A | B | Example 5 | Example 6 |
| Allyl glycol | 31 | | 41 | 33 | |
| N-vinyl formamide | 25 | 25 | 21 | 25 | |
| Tripropylene | 25 | 67.9 | | 25 | 55 |
| glycol | | | | | |
| diacrylate | | | | | |
| Trimethylolpropane | 8 | | 33 | 8 | 34 |
| triacrylate | | | | | |
| EO adduct | | | | | |
| Irgacure 1800 | 5 | 5 | | 5 | 5 |
| Darocur EHA | 1 | 1 | 1 | | 1 |
| Darocur ITX | 1 | 1 | | | 1 |
| BYK-UV 3570 | 0.1 | 0.1 | 0.1 | 0.1 | 0.1 |
| Pigment violet-19 | 3 | | 3 | 3 | 3 |
| Dispersing agent | 0.9 | | 0.9 | 0.9 | 0.9 |
| (polyoxyalkylene | | | | | |
| polyalkylene | | | | | |
| polyamine) | | | | | |

[Table 4]

TABLE 4
Yellow

| | Exam- | Example 8 | | Comparative | Comparative |
|---|---|---|---|---|---|
| | ple 7 | A | B | Example 7 | Example 8 |
| Allyl glycol | 31.3 | | 41 | 33.3 | |
| N-vinyl formamide | 25 | 25 | 21.3 | 25 | |
| Tripropylene | 25 | 67.9 | | 25 | 55 |
| glycol | | | | | |
| diacrylate | | | | | |
| Trimethylolpropane | 8 | | 33 | 8 | 34.3 |
| triacrylate | | | | | |
| EO adduct | | | | | |
| Irgacure 1800 | 5 | 5 | | 5 | 5 |
| Darocur EHA | 1 | 1 | 1 | | 1 |
| Darocur ITX | 1 | 1 | | | 1 |
| BYK-UV 3570 | 0.1 | 0.1 | 0.1 | 0.1 | 0.1 |
| Pigment yellow-155 | 3 | | 3 | 3 | 3 |
| Dispersing agent | 0.6 | | 0.6 | 0.6 | 0.6 |
| (polyoxyalkylene | | | | | |
| polyalkylene | | | | | |
| polyamine) | | | | | |

[Evaluation of Viscosity]

The initial viscosity at 25° C. of each ink composition of the above-mentioned Examples 1 to 8 and Comparative Examples 1 to 8 was measured. Table 5 shows the result.

[Table 5]

TABLE 5
Viscosity (mPa · s/25° C.)

| | | |
|---|---|---|
| Example 2 | Comparative | Comparative |

| Example 1 | A | B | Example 1 | Example 2 |
|---|---|---|---|---|
| 9.2 | 10.3 | 6 | 9.1 | 25 |

| | | |
|---|---|---|
| Example 4 | Comparative | Comparative |

| Example 3 | A | B | Example 3 | Example 4 |
|---|---|---|---|---|
| 8.8 | 9.9 | 5.6 | 8.7 | 24.6 |

| | | |
|---|---|---|
| Example 6 | Comparative | Comparative |

| Example 5 | A | B | Example 5 | Example 6 |
|---|---|---|---|---|
| 8.5 | 10.6 | 5.3 | 8.4 | 24.3 |

| | | |
|---|---|---|
| Example 8 | Comparative | Comparative |

| Example 7 | A | B | Example 7 | Example 8 |
|---|---|---|---|---|
| 9.2 | 10.3 | 6 | 9.1 | 25 |

[Evaluation of Preservation Stability]

The initial viscosity (25° C.) of each ink composition of the above-mentioned Examples 1 and 2 and Comparative Examples 1 and 2 and their viscosity after leaving them under conditions of at 60° C. for 7 days were measured for evaluation of preservation stability. Table 6 shows the results.

Index of preservation stability evaluation
A: viscosity change between the initial viscosity and that after the leaving is less than ±50.
B: viscosity change between the initial viscosity and that after the leaving is ±50% or more and less than ±100%.
C: viscosity change between the initial viscosity and that after the leaving is 100% or more.

[Table 6]

TABLE 6
Evaluation of preservation stability

| | | Example 2 | | Comparative | Comparative |
|---|---|---|---|---|---|
| | Example 1 | A | B | Example 1 | Example 2 |
| Conclusion | A | A | A | A | C |

[Curing Property Test (on Glass Substrate)]

Each ink composition of the above-mentioned Examples 1 to 8 and Comparative Examples 1 to 8 was dropwise applied to a glass substrate and treated under curing conditions of irradiation with ultraviolet light having a wavelength of 365 nm, a light intensity of 17 mW/cm², an irradiation time of 6 sec, and an integrated light dose of 102 mJ/cm². Visual evaluation of the following curing property was conducted.

Index of curing property evaluation
A: completely cured
B: uncured at a part of surface

[Table 7]

TABLE 7
Evaluation of curing property (on glass substrate)

| | | Example2 | | Comparative | Comparative |
|---|---|---|---|---|---|
| | Example 1 | A | B | Example 1 | Example 2 |
| Surface condition | A | A | | B | A |
| | | Example 4 | | Comparative | Comparative |
| | Example 3 | A | B | Example 3 | Example 4 |
| Surface condition | A | A | | B | A |
| | | Example 6 | | Comparative | Comparative |
| | Example 5 | A | B | Example 5 | Example 6 |
| Surface condition | A | A | | B | A |
| | | Example 8 | | Comparative | Comparative |
| | Example 7 | A | B | Example 7 | Example 8 |

| | | | | |
|---|---|---|---|---|
| Surface condition | A | A | B | A |

[Curing Property Test (use of Ink Jet Printer)]

An ink jet printer PX-G900 manufactured by Seiko Epson Corp. was used. Each ink composition of the above-mentioned Examples 1 to 8 and Comparative Examples 1 to 8 was put into the corresponding color columns of the printer, and a solid pattern was printed at normal temperature and normal pressure. An OHP film of A4 size (XEROX FILM (without frame) manufactured by Fuji Xerox Co., Ltd.) was used as a recording medium. Printing and curing treatment were conducted with an ultraviolet light irradiation source provided at a paper delivery outlet under curing conditions that the integrated light dose at 365 nm was 200 mJ/cm². The curing property was evaluated by the following indexes.

Index of curing property evaluation
A: completely cured
B: uncured at a part of surface
C: printing unable

[Table 8]

TABLE 8
Evaluation of curing property (use of ink jet printer)

| | | Example 2 | | Comparative | Comparative |
|---|---|---|---|---|---|
| | Example 1 | A | B | Example 1 | Example 2 |
| Surface condition | A | A | | B | C |
| | | Example 4 | | Comparative | Comparative |
| | Example 3 | A | B | Example 3 | Example 4 |
| Surface condition | A | A | | B | C |
| | | Example 6 | | Comparative | Comparative |
| | Example 5 | A | B | Example 5 | Example 6 |
| Surface condition | A | A | | B | C |
| | | Example 8 | | Comparative | Comparative |
| | Example 7 | A | B | Example 7 | Example 8 |

| | | | | |
|---|---|---|---|---|
| Surface condition | A | A | B | C |

It is obvious from Table 5 that the ink compositions of Examples 1 to 8 have lower viscosity compared to ink compositions of Comparative Examples 2, 4, 6, and 8 which do not contain compounds having an allyl group and N-vinyl compounds. It is also obvious from Tables 6 to 8 that the ink compositions of Examples are superior in both preservation stability and curing property compared to ink compositions of Comparative Examples.

### Examples 9-1 to 9-4

Ink compositions shown in Tables 9 to 12 were prepared. Proportions of each component of the ink compositions are expressed by parts by weight. Table 9 shows black (Example 9-1), and Bk-1 to Bk-7 in the table represent test samples. Table 10 shows cyan (Example 9-2), and C-1 to C-7 represent samples. Table 11 shows magenta (Example 9-3), and M-1 to M-7 represent samples. Table 12 shows yellow (Example 9-4), and Y-1 to Y-7 represent samples.

In ink compositions of Examples 9-1 to 9-4 shown in Tables 9 to 12, “allyl glycol” was used as the compound having an allyl group (polymerizable compound), “N-vinyl formamide and N-vinylcaprolactam” were used as the N-vinyl compound (polymerizable compound), “Darocur ITX and Kayacure DETX-s” were used as the thioxanthone (polymerization accelerator), and “Darcur EHA” was used as the amine (polymerization accelerator).

[Table 9]

TABLE 9

| | Example 9-1 | | | | | | |
|---|---|---|---|---|---|---|---|
| | Bk-1 | Bk-2 | Bk-3 | Bk-4 | Bk-5 | Bk-6 | Bk-7 |
| Allyl glycol | 32.2 | 57.2 | 57.2 | | | 31.2 | 31.2 |
| N-vinyl formamide (N-vinyl compound) | 25 | | | 25 | 25 | | 25 |
| N-vinylcaprolactam (N-vinyl compound) | | | | | | 25 | |
| Tripropylene glycol diacrylate | 25 | 25 | 25 | 65.2 | 65.2 | 25 | 25 |
| Trimethylolpropane triacrylate EO adduct | 8 | 8 | 8 | | | 8 | 8 |
| Irgacure 1800 | 5 | 5 | 5 | 5 | 5 | 5 | 5 |
| Darocur EHA | 1 | 1 | | 1 | | 1 | 1 |
| Darocur ITX (thioxanthone) | | | 1 | | 1 | 1 | |
| kayacureDETX-s (thioxanthone) | | | | | | | 1 |
| BYK-UV 3570 | 0.1 | 0.1 | 0.1 | 0.1 | 0.1 | 0.1 | 0.1 |
| Pigment black-7 | 3 | 3 | 3 | 3 | 3 | 3 | 3 |
| Dispersing agent | 0.7 | 0.7 | 0.7 | 0.7 | 0.7 | 0.7 | 0.7 |

[Table 10]

TABLE 10

| | Example 9-2 | | | | | | |
|---|---|---|---|---|---|---|---|
| | C-1 | C-2 | C-3 | C-4 | C-5 | C-6 | C-7 |
| Allyl glycol | 32.2 | 57.2 | 57.2 | | | 31.2 | 31.2 |
| N-vinyl formamide | 25 | | | 25 | 25 | | 25 |
| N-vinylcaprolactam | | | | | | 25 | |
| Tripropylene glycol | 25 | 25 | 25 | 65.2 | 65.2 | 25 | 25 |
| diacrylate | | | | | | | |
| Trimethylolpropane | 8 | 8 | 8 | | | 8 | 8 |
| triacrylate EO adduct | | | | | | | |
| Irgacure 1800 | 5 | 5 | 5 | 5 | 5 | 5 | 5 |
| Darocur EHA | 1 | 1 | | 1 | | 1 | 1 |
| Darocur ITX | | | 1 | | 1 | 1 | |
| kayacureDETX-s | | | | | | | 1 |
| BYK-UV 3570 | 0.1 | 0.1 | 0.1 | 0.1 | 0.1 | 0.1 | 0.1 |
| Pigment blue-15:3 | 3 | 3 | 3 | 3 | 3 | 3 | 3 |
| Dispersing agent | 0.7 | 0.7 | 0.7 | 0.7 | 0.7 | 0.7 | 0.7 |

[Table 11]

TABLE 11

| | Example 9-3 | | | | | | |
|---|---|---|---|---|---|---|---|
| | M-1 | M-2 | M-3 | M-4 | M-5 | M-6 | M-7 |
| Allyl glycol | 32 | 57 | 57 | | | 31 | 31 |
| N-vinyl formamide | 25 | | | 25 | 25 | | 25 |
| N-vinylcaprolactam | | | | | | 25 | |
| Tripropylene glycol | 25 | 25 | 25 | 65 | 65 | 25 | 25 |
| diacrylate | | | | | | | |
| Trimethylolpropane | 8 | 8 | 8 | | | 8 | 8 |
| triacrylate EO adduct | | | | | | | |
| Irgacure 1800 | 5 | 5 | 5 | 5 | 5 | 5 | 5 |
| Darocur EHA | 1 | 1 | | 1 | | 1 | 1 |
| Darocur ITX | | | 1 | | 1 | 1 | |
| kayacureDETX-s | | | | | | | 1 |
| BYK-UV 3570 | 0.1 | 0.1 | 0.1 | 0.1 | 0.1 | 0.1 | 0.1 |
| Pigment violet-19 | 3 | 3 | 3 | 3 | 3 | 3 | 3 |
| Dispersing agent | 0.9 | 0.9 | 0.9 | 0.9 | 0.9 | 0.9 | 0.9 |

[Table 12]

TABLE 12

| Example 9-4 | Y-1 | Y-2 | Y-3 | Y-4 | Y-5 | Y-6 | Y-7 |
|---|---|---|---|---|---|---|---|
| Allyl glycol | 32.3 | 57.3 | 57.3 | | | 31.3 | 31.3 |
| N-vinyl formamide | 25 | | | 25 | 25 | | 25 |
| N-vinylcaprolactam | | | | | | 25 | |
| Tripropylene | 25 | 25 | 25 | 65.3 | 65.3 | 25 | 25 |
| glycol diacrylate | | | | | | | |
| Trimethylolpropane | 8 | 8 | 8 | | | 8 | 8 |
| triacrylate EO adduct | | | | | | | |
| Irgacure 1800 | 5 | 5 | 5 | 5 | 5 | 5 | 5 |
| Darocur EHA | 1 | 1 | | 1 | | 1 | 1 |
| Darocur ITX | | | 1 | | 1 | 1 | |
| kayacureDETX-s | | | | | | | 1 |
| BYK-UV 3570 | 0.1 | 0.1 | 0.1 | 0.1 | 0.1 | 0.1 | 0.1 |
| Pigment yellow-155 | 3 | 3 | 3 | 3 | 3 | 3 | 3 |
| Dispersing agent | 0.6 | 0.6 | 0.6 | 0.6 | 0.6 | 0.6 | 0.6 |

[Evaluation of Viscosity]

As in the above-mentioned Example 1, each ink composition of Examples 9-1 to 9-4 shown in Tables 9 to 12 was measured for initial viscosity at 25° C. Table 13 shows the results.

[Table 13]

TABLE 13
Initial viscosity measurement

| Example 9-1 | Bk-1 | Bk-2 | Bk-3 | Bk-4 | Bk-5 | Bk-6 | Bk-7 |
|---|---|---|---|---|---|---|---|
| Initial viscosity | 9.2 | 10.5 | 10.5 | 13.5 | 13.5 | 9.7 | 9.2 |
| mPa · s/25° C. | | | | | | | |
| Example 9-2 | C-1 | C-2 | C-3 | C-4 | C-5 | C-6 | C-7 |
| Initial viscosity | 8.8 | 10.1 | 10.1 | 13.1 | 13.1 | 9.3 | 8.8 |
| mPa · s/25° C. | | | | | | | |
| Example 9-3 | M-1 | M-2 | M-3 | M-4 | M-5 | M-6 | M-7 |
| Initial viscosity | 8.5 | 10.8 | 10.8 | 13.8 | 13.8 | 9 | 8.5 |
| mPa · s/25° C. | | | | | | | |
| Example 9-4 | Y-1 | Y-2 | Y-3 | Y-4 | Y-5 | Y-6 | Y-7 |
| Initial viscosity | 9.2 | 10.5 | 10.5 | 13.5 | 13.5 | 9.7 | 9.2 |
| mPa · s/25° C. | | | | | | | |

[Evaluation of Preservation Stability]

The initial viscosity (25° C.) of each ink composition shown in Table 9 (Examples 9-1: Bk-1 to Bk-7) and their viscosity after leaving them under conditions of at 60° C. for 7 days were measured for evaluation of preservation stability. Table 14 shows the results.

Index of Preservation Stability Evaluation

A: viscosity change between the initial viscosity and that after the leaving is less than ±50.

B: viscosity change between the initial viscosity and that after the leaving is ±50% or more and less than ±100%.

C: viscosity change between the initial viscosity and that after the leaving is 100% or more.

[Table 14]

TABLE 14
Evaluation of preservation stability

| Example 9-1 | Bk-1 | Bk-2 | Bk-3 | Bk-4 | Bk-5 | Bk-6 | Bk-7 |
|---|---|---|---|---|---|---|---|
| Conclusion | A | A | A | A | A | A | A |

[Curing Property Test (on Glass Substrate)]

Each ink composition of Examples 9-1 to 9-4 shown in Tables 9 to 12 was dropwise applied to a glass substrate and treated under curing conditions of irradiation with ultraviolet light having a wavelength of 365 nm, a light intensity of 17 mW/cm², an irradiation time of 6 sec, and an integrated light dose of 102 mJ/cm². Visual evaluation of the following curing property was conducted. Table 15 shows the results.

Index of curing property evaluation

A: completely cured

B: uncured at a part of surface

[Table 15]

TABLE 15
Evaluation of curing property (on glass substrate)

| Example 9-1 | Bk-1 | Bk-2 | Bk-3 | Bk-4 | Bk-5 | Bk-6 | Bk-7 |
|---|---|---|---|---|---|---|---|
| Surface condition | A | A | A | A | A | A | A |
| Example 9-2 | C-1 | C-2 | C-3 | C-4 | C-5 | C-6 | C-7 |
| Surface condition | A | A | A | A | A | A | A |
| Example 9-3 | M-1 | M-2 | M-3 | M-4 | M-5 | M-6 | M-7 |
| Surface condition | A | A | A | A | A | A | A |
| Example 9-4 | Y-1 | Y-2 | Y-3 | Y-4 | Y-5 | Y-6 | Y-7 |
| Surface condition | A | A | A | A | A | A | A |

[Curing Property Test (use of Ink Jet Printer)]

An ink jet printer PX-G900 manufactured by Seiko Epson Corp. was used. Each ink composition of Examples 9-1 to 9-4 shown in Tables 9 to 12 was put into the corresponding color columns of the printer, and a solid pattern was printed at normal temperature and normal pressure. An OHP film of A4 size (XEROX FILM (without frame) manufactured by Fuji Xerox Co., Ltd.) was used as a recording medium. Printing and curing treatment were conducted with an ultraviolet light irradiation source provided at a paper delivery outlet under curing conditions that the integrated light dose at 365 nm was 200 mJ/cm². The curing property was evaluated by the following indexes. Table 16 shows the results.

Index of curing property evaluation

A: completely cured

B: uncured at a part of surface

C: printing unable

[Table 16]

TABLE 16
Evaluation of curing property (use of ink jet printer)

| Example 9-1 | Bk-1 | Bk-2 | Bk-3 | Bk-4 | Bk-5 | Bk-6 | Bk-7 |
|---|---|---|---|---|---|---|---|
| Surface condition | A | A | A | A | A | A | A |
| Example 9-2 | C-1 | C-2 | C-3 | C-4 | C-5 | C-6 | C-7 |
| Surface condition | A | A | A | A | A | A | A |
| Example 9-3 | M-1 | M-2 | M-3 | M-4 | M-5 | M-6 | M-7 |
| Surface condition | A | A | A | A | A | A | A |
| Example 9-3 | Y-1 | Y-2 | Y-3 | Y-4 | Y-5 | Y-6 | Y-7 |
| Surface condition | A | A | A | A | A | A | A |

As described above, it is obvious from Table 13 that ink compositions of Examples 9-1 to 9-4 have “low viscosity” and obvious from Tables 14 to 16 that the ink compositions are superior in both “preservation stability and curing property”.

### Examples 10-1 to 10-6 and Comparative Examples 9-1 and 9-2

Photo-curing ink compositions shown in Table 17 were prepared. Proportions of each component of the ink compositions are expressed by parts by weight. In ink compositions shown in Table 17, “allyl glycol” was used as the compound having an allyl group (polymerizable compound), “N-vinyl formamide” was used as the N-vinyl compound (polymerizable compound), and “Darcur EHA” was used as the amine (polymerization accelerator).

[Table 17]

TABLE 17

| | |
|---|---|
| N-vinyl formamide | 25 |
| Allyl glycol | 32.2 |
| Tripropylene glycol diacrylate | 25 |
| Trimethylolpropane EO adduct triacrylate | 8 |
| Irgacure 819 | 4 |
| Irgacure 369 | 1 |
| Darocur EHA | 1 |
| BYK-UV 3570 | 0.1 |
| Pigment black-7 | 3 |
| Dispersing agent (polyoxyalkylene | 0.7 |
| polyalkylene polyamine) | |

[Evaluation of Upper Limit of Time Till Irradiation]

Each of the ultraviolet light-curing ink composition shown in Table 17 was dropwise applied to a glass substrate and treated under curing conditions of irradiation with ultraviolet light having a wavelength of 365 nm, a light intensity of 17 mW/cm², an irradiation time of 10 sec, and an integrated light dose of 170 mJ/cm² after a time period of 3 sec (Example 10-1), 5 sec (Example 10-2), 10 sec (Example 10-3), sec (Example 10-4), or 30 sec (Comparative Example 9-1) from the ink application. The surface conditions were visually evaluated by the following indexes. Table 18 shows the results.

Index of visual evaluation of surface condition

A1: completely cured

B1: uncured at a part of surface (practical level)

C1: uncured at parts of surface and inside

[Table 18]

TABLE 18

| Time period | | |
|---|---|---|
| till irradiation (s) | | |
| 3 | A₁ | Example 10-1 |
| 5 | A₁ | Example 10-2 |
| 10 | B₁ | Example 10-3 |
| 20 | B₁ | Example 10-4 |
| 30 | C₁ | Comparative Example 9-1 |

[Evaluation of Lower Limit of Time Till Irradiation]

An ink jet printer PX-G900 manufactured by Seiko Epson Corp. was used, and a solid pattern was printed at normal temperature and normal pressure on a PC sheet (Panlite sheet manufactured by Teijin Ltd.,) using each of the ultraviolet light-curing ink compositions shown in Table 17. Devices which can change the time period from the ink discharge till irradiation of ultraviolet light having a wavelength of 365 nm at a light intensity of 17 mW/cm² by the distance from a recording head were provided at both sides of the recording head. By changing the distance from the recording head of the ultraviolet light-irradiating device, irradiation treatment under curing conditions of an irradiation time of 10 sec and an integrated light dose of 170 mJ/cm² was conducted after a time period of 0.05 sec (Comparative Example 9-1), 0.1 sec (Example 10-5), or 0.5 sec (Example 10-6) till the irradiation from the ink application. The surface conditions were visually evaluated by the following indexes. Table 19 shows the results.

Index of visual evaluation of surface condition

A2: solid pattern is uniformly produced and cured

B2: solid pattern having slight lines in produced and cured (practical level)

C2: solid pattern having lines is produced and cured

[Table 19]

TABLE 19

| Time period | | |
|---|---|---|
| till irradiation (s) | | |
| 0.05 | C₂ | Comparative Example 9-2 |
| 0.1 | B₂ | Example 10-5 |
| 0.5 | A₂ | Example 10-6 |

As obvious from Tables 18 and 19, the ink compositions shown in Table 17 can be cured and an image with high quality not producing lines in a solid pattern can be formed by starting the light-irradiation 0.1 to 20 sec after the discharge of the ink from a head to a recording medium (see Examples 10-1 to 10-6) unlike the cases out of this range (see Comparative Examples 9-1 and 9-2).

1-13. (canceled)

14. A photo-curing ink composition, the ink composition containing at least one of a compound having an allyl group and an N-vinyl compound as a polymerizable compound and at least one of thioxanthone and an amine as a polymerization accelerator.

15. The photo-curing ink composition according to claim 14, wherein the compound having an allyl group is allyl glycol.

16. The photo-curing ink composition according to claim 14, wherein the N-vinyl compound is N-vinyl formamide.

17. The photo-curing ink composition according to claim 14, wherein the amine is aminobezoate.

18. The photo-curing ink composition according to claim 14, wherein the ink composition contains 20 to 80 percents by weight of at least one of the compound having an allyl group and the N-vinyl compound.

19. The photo-curing ink composition according to claim 14, wherein the photo-curing ink composition is a two-liquid type ink composition.

20. The photo-curing ink composition according to claim 14, wherein the photo-curing ink composition is light-curable with ultraviolet light

21. An ink jet recording method comprising discharging the photo-curing ink composition according to claim 14 from a recording head to a recording medium, wherein light irradiation starts 0.1 to 20 seconds after the discharge of the photo-curing ink composition from the head to the recording medium.

22. The ink jet recording method according to claim 21, wherein the photo-curing ink composition is a two-liquid type ink composition and the two liquids of the ink composition are mixed before the discharge from a head.

23. The ink jet recording method according to claim 21, wherein the photo-curing ink composition is a two-liquid type ink composition and the two liquids of the ink composition are mixed on a recording medium.

24. The ink jet recording method according to claim 21, comprising light curing of the photo-curing ink composition, wherein the light curing is ultraviolet light-curing and a light source for the light irradiation is a light-emitting diode or a laser diode.

25. An ink jet recording apparatus comprising the photo-curing ink composition according to claim 14, the apparatus having a mechanism for starting light irradiation 0.1 to 20 seconds after discharge of the photo-curing ink composition from a head to a recording medium.
